(19) United States
(12) Patent Application Publication
(10) Pub. No.: US 2003/0007020 A1
(43) Pub. Date: Jan. 9, 2003

(54) Programming interface for chart recorders and other instruments

(76) Inventor: Matthew Levine, Boca Raton, FL (US)

Correspondence Address: John G. Posa, Gifford, Krass, Groh et al, Suite 400, 280 N. Old Woodward Ave., Birmingham, MI, 48009, US

(21) Appl. No.: 09/968,085

(22) Filed: Oct. 1, 2001

Related U.S. Application Data
(63) Continuation-in-part of application No. 09/900,787, filed on Jul. 6, 2001.

(51) Int. Cl. G01D 9/28; G01D 9/36; G01D 15/16

(52) U.S. Cl. 346/52; 346/112

(57) ABSTRACT

A chart recorder or other applicable instrument uses the recording medium for programming purposes, thereby obviating the need for additional keypads and/or displays. By placing the recording medium onto the recorder, and by moving the pen and/or medium to select among the available options, the unit is automatically programmed in accordance with the selections. Position is known due to the spatial alignment with a start position, resulting in an unambiguous programming. In addition to circular chart recorders, the invention applies to strip-chart recorders, plotters, printers, and other pieces of equipment wherein the position of a marker and/or paper or other substrate is known or determinable. An advantage of the invention is that the chart is produced in confirmation of the settings, thereby leaving a user or operator with a printed record of the way in which the unit was programmed. In the preferred embodiment, a chart is provided having a comprehensive list of certain options imprinted thereon, whereby the user moves the pen so as to strike out desirable options. Alternatively, however, the pen may be used to select desired options by underlining, highlighting, or visual registration without actually marking a surface. Imprinted areas and labels may be used in lieu of a chart or other recording medium.

### REFERENCE TO RELATED APPLICATION

This application is a continuation-in-part of U.S. patent application Ser. No. 09/900,787, filed Jul. 6, 2001, the entire contents of which is incorporated herein by reference.

### FIELD OF THE INVENTION

This invention relates generally to recording instruments such as chart recorders of the type used to monitor temperature, humidity, vibration, and so forth, and, in particular, to apparatus and methods which allow a user to more easily program such units.

### BACKGROUND OF THE INVENTION

Although chart recorders have been commercially available for many years, they remain necessary in many applications, including the monitoring of temperature, humidity, vibration, and other conditions, particularly over prolonged periods of time. For this reason, chart recorders are used in various situations, including the monitoring of temperature/humidity in museums, environmental monitoring of blood products in hospital settings, and so forth. In these and other applications, chart recorders are the best instruments to certify the processes which they are used to measure.

Although chart recorder operation has remained essentially the same for quite some time, numerous features have been added, requiring a user to program the unit to record at a particular scale or time sequence, to recognize the password of particular users, and other settings. Existing units are programmed in much the same way that other pieces of electronic equipment are programmed, namely, by entering commands through some form of keypad, with results being displayed on some form of alphanumeric readout.

This type of chart recorder programming currently in use has at least two disadvantages. For one, separate keypads and displays are relatively expensive items, precluding product applicability to certain very cost-sensitive markets. The addition of keypads and displays also adds further components which could break down, resulting in maintenance issues. Secondly, even with a dedicated keypad and display, programming sequences may be complicated and difficult to understand, leading to prolonged procedures, and possible operator error.

The need remains, therefore, for a chart recorder which is more easily programming while, at the same time, utilizes a human interface which does not substantially raise costs.

### SUMMARY OF THE INVENTION

This invention improves upon the prior art by providing a chart recorder which uses the chart itself in the preferred embodiment for programming purposes, thereby obviating the need for additional keypads and/or displays. Although the invention is described in terms of a circular chart recorder, the concept is not limited in this regard, and may apply to strip-chart recorders, plotters, printers, and other pieces of equipment wherein a pen or other implement(s) is used to mark a paper or other substrate.

Broadly, using a circular chart recorder as an example, a chart is provided having indicia printed in predetermined locations on the chart, such indicia having to do with the programming of the recorder. By placing this chart onto the recorder, and by moving the pen and/or chart to select among the available options, the unit is automatically programmed in accordance with the selections, without the need for controls other than those used for pen and/or chart movement. Another advantage of the invention is that a printed record is produced, thereby leaving a user or operator with a confirmation of the settings according to which the chart was programmed. A programming log may also be stored, preferably in a non-volatile memory such as an EE-PROM, and printed out for verification or archival purposes.

In the preferred embodiment, a “set-up” chart is provided having a comprehensive list of certain options imprinted thereon, whereby the user moves the pen to strike out those options which the user desires. Alternatively, desired options may be indicated by underlining, striking out undesired options, or by simply moving the pen and/or paper to desired or undesired options (without a printed record), depending upon the way in which the unit is configured.

Although a chart which moves into two directions is desirable, such a feature is not necessary to the invention, since unidirectional pen or chart movement may be used to access appropriate portions of the chart for programming purposes. Although a specialized chart is preferably provided for programming, each chart actually used may also have programming indicia imprinted thereon, preferably using a lighter shade that does not interfere with scale markings. An overlay or encoded matrix, label, or more permanently imprinted area outside of, of under, the chart may alternatively be used. In any case, programming is unambiguous since the position of the chart is known due to the spatial alignment with the start position.

### BRIEF DESCRIPTION OF THE DRAWING

FIG. 1 is a drawing of a set-up chart according to the invention enabling a user to program a recorder using chart and pen movements;

FIG. 2 is a drawing of the set-up chart of FIG. 1 following a programming operation; and

FIG. 3 is a drawing of an alternative configuration used to program a recording instrument according to the invention.

### DETAILED DESCRIPTION OF THE INVENTION

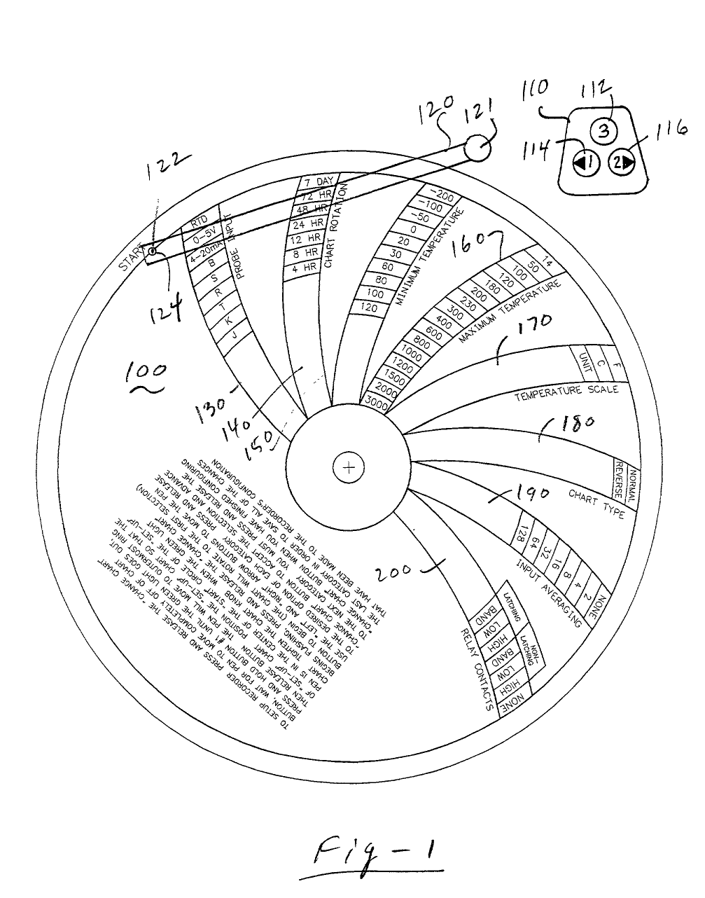

FIG. 1 is a drawing which shows a set-up chart 100 according to the invention, having placed on a chart recorder with controls 110. The controls 110 including one or more buttons such as 112, 114 and 116 used to control the device, including chart and/or pen movement, mode changing, and so forth. The pen arm is shown at 120, having placed a dot 122 at start position 124. Note that, in subsequent drawings, for the sake of clarity, only the marks made by the pen, and not the pen arm itself, will be shown.

The chart shown is a 10-inch chart, though the invention is applicable to other types of charts and recorders, including circular charts having different diameters. The chart 100 contains a series of columns 130, 140, 150, 160, 170, 180, 190, 200, each assuming a semi-circular pattern because pen which pivots at 121 traces a circle as opposed to a straight line. Although there are eight columns, each with up to 16 entries (as in the case of column 160), this was chosen for convenience includes. It will be appreciated that the invention is applicable to more or fewer columns, with more or fewer entries in each case, and may be located anywhere on the chart surface.

Column 130, labeled PROBE INPUT, includes entries for typical inputs which most recorders in a particular class are capable of accepting. The next column, 140, entitled CHART ROTATION, includes entries for one rotation every seven days, down to four hours. Again, space may be added for more rotations, if the need arises. Columns 150 and 160 are used to program MINIMUM TEMPERATURE and MAXIMUM TEMPERATURE, respectively. Thus, if the user chooses 0 in column 150, then advances to column 160 and chooses 100, the unit will then be compatible with a 0-to-100 chart.

TEMPERATURE SCALE, provided on column 170, is used to select degrees Fahrenheit, degrees Celcius, or units. For example, the device might have a unit scale of 420 milliamps representative of pressure, humidity, etc., and not necessarily corresponding to a ° C. or ° F. The CHART TYPE column (180)—normal or reverse—allows the user to select whether or the minimum temperature or the maximum temperature will be referenced to the outside edge of the chart. Normally, the highest temperature is at the outside of the chart, and the smallest number is closer to the inner ring. If the user's chart happened to be the opposite of that, a reverse type chart would be selected.

Column 190 is used to select input averaging for the probe; for instance in an environment where the probe leads are lengthy or in a very noisy environment, one may wish to select more averaging of the samples so as smooth out the line drawn by the recorder. The converse of that is fewer samples may be desirable as the result will be a faster response time for the recorder. Finally, column 200 is associated with RELAY CONTACTS. In this case, if a relay option available, the relay may be latched. For example, if the relay set point is set for 80° and this is exceeded and latching has been selected, the unit will stay in the alarm mode without being reset. With non-latching, if the sensed condition returned to a point below the set point, this would release the relay or put the relay in the non-alarm condition.

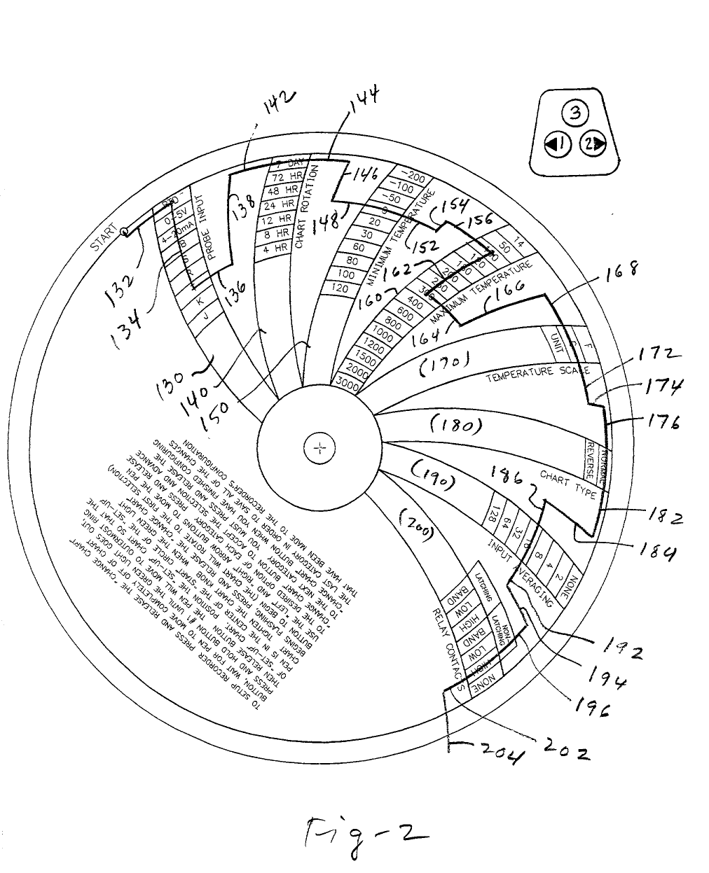

Reference will now be made to FIG. 2, which illustrate the way in which the instrument is programmed according to the invention. Having placed the chart on the recorder with the pen aligned to the start position, controls 110 are used to select among the available options. This particular unit has been programmed such that if button 114 is held down for 12 seconds, the programming mode is activated. Other controls, including other buttons and combinations thereof, may alternatively be used. Note also that the unit has already been programmed, such that in advancing through the various stages, some none or all of the variables may be changed, as follows.

Upon pushing the ENTER button (3), the chart and pen automatically move to select RTD with line as shown in FIG. 2, since this was the mode in which the unit was previously programmed. The RTD selection may be retained by depressing button 112, advancing to the next column or, by using buttons 114 and 116 to control pen movement, the selection may be changed. The unit has been programmed such that one depression of buttons 114 and 116 advances the pen one entry within a column in either direction. As such, by pressing button 116 six times, the T thermocouple has been selected, as shown with line 134. As an alternative to automatic incrementing, the unit may be programmed such that holding down a particular button results in movement until the finger is lifted.

Now button 112 is pressed, causing the pen to automatically advance to the next column. Since the unit was previously programmed for 7-day operation, the pen advances to the outermost entry of column 140. Note, however, that the advance occurs in three segments 136, 138, and 142, with segment 138 being between columns 130 and 140. This is an important feature, since it allows a clear and unambiguous recall of the recorder settings. If the pen came straight over 4-hour then went to seven day, there would already be a line already drawn through column 140, which could be confusing.

Assuming 7-day operation is acceptable, pressing button 112 causes the system to advance to column 150 and 0° in particular along segments 144, 146 and 148, since this represents the way in which the unit was previously programmed. Again, assuming 0° is acceptable, button 112 is pressed again, advancing to column 160 and 100°, also previously programmed, along segments 152, 154 and 156. However, now the maximum has been changed from 100° to 300° by pressing button 116 five times, causing the pen to increment along line 162 until reaching the 300° entry.

Programming proceeds in like manner through segments 164, 166 and 168 to show that degrees C. was previously programmed. This is retained, causing the pen to progress to NORMAL chart type through segments 172, 174, and 176. This is retained, and the pen progresses to an input averaging of 16 through segments 182, 184, and 186. This is also retained, and the pen is advanced to HIGH non-latching relay contacts through line segments 192, 194, and 196. This is also maintained, and the pen moves off the chart through segments 202 and 204 to terminate programming.

By virtue of the invention, certain operations are immediately apparent by observing the programmed chart. Note for example, that columns with changes will include a radial segment whereas, with unchanged columns, the line will enter and leave through the same entry. In this case, the pen came in as an RTD, but exited as a type T thermocouple. The unit was previously programmed for 7 days, which was left alone, resulting in a “horizontal” line through the entry, and so forth.

Note also, that if the user merely wants a recall of programmed criteria, a programming chart may be placed on the unit and, by repeatedly hitting the No. 3 button, a line is drawn straight through every unchanged variable. This feature allows a user or supervisor to see whether or not somebody has tampered with the unit or changed programming. This is also very useful for diagnostics, for proof that the unit is programmed correctly. Although some existing units include digital displays, the recorder itself may be permanently installed. Without a cellular phone or wired phone nearby, a user must memorize the display information or go back and forth to the unit to confirm operational settings. In contrast, this invention allows a chart to be removed and carried away. As such, the chart may be taken to a fax machine to confirm setup features without having to be near the recorder in order to discuss how it has been set up.

According to this invention, there is a correspondence between the position of the marking implement relative to positions on the chart surface. This correspondence may be implemented is different ways, so long as the recorder “knows” where it is sufficient to facilitate programming. For example, as described above, the unit may be programmed to store rotational and pen-arm increments relative to a start position. Alternatively, given an initial or start position, the device may store a one- or two-dimensional map of the surface to be marked, enabling a user to advance to any location from any direction to select a particular parameter. Once a chart, for example, has been initialized in this way, movement of the pen at to particular point of the chart is known through stored position data, enabling a correlation between pen position and programming indicia to be determined, selected and stored.

Although both chart and pen movements have been described, in alternative embodiments only the pen or chart is moved. For example, in the case of a circular chart, if the programming information is limited to one ring, the chart may be rotated with a non-pivoting pen that only moves up and down to select desired programming features. Such a configuration might advantageously use an outer ring, perhaps outside of the recording area, enabling the rest of the chart to be used for recording purposes. Indeed, after programming, the unit may be programmed to automatically draw the recording area of the chart in accordance with the criteria selected. Alternatively, if only one column is used for programming, the chart may remain stationary, with the pen pivoting and moving up and down to select the desired programming features. In addition, although the pen is shown marking the chart, this is not strictly necessary to the invention. Note that if the pen advances or is moved to a particular location, whether during programming or recall, such operations may be carried out by simply observing the movements of the pen relative to the surface of the chart without actually touching it.

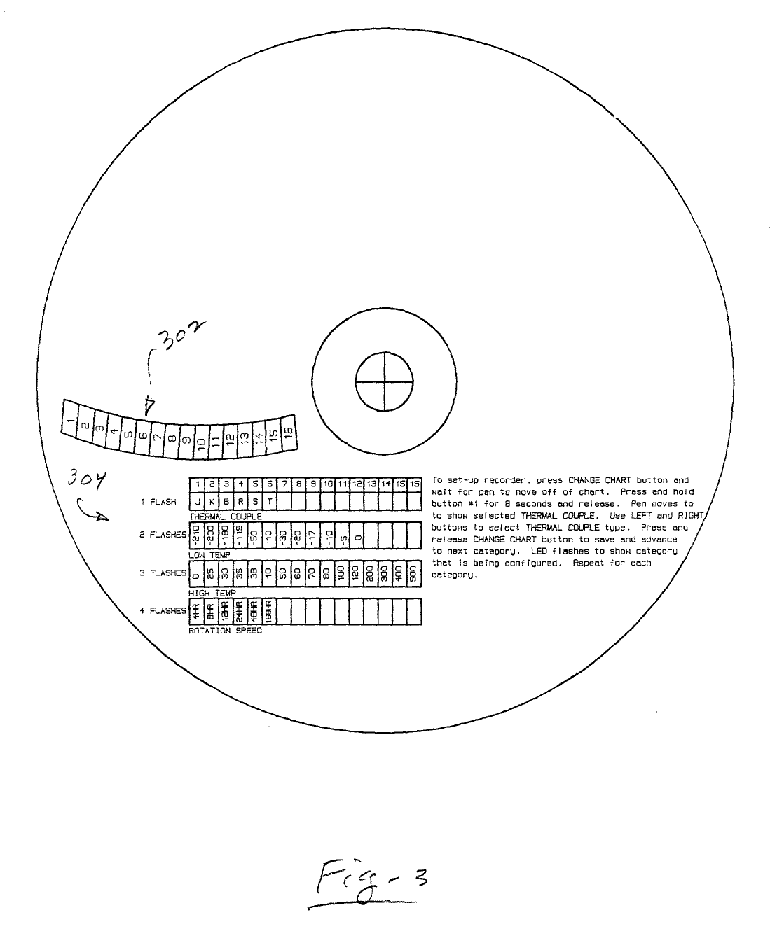

Although a “set-up chart” is shown, it should also be evident that the chart actually used for recording may also be used for programming purposes, with the visual indicia perhaps being printed in a faint manner or different color so as not to interfere with the actual recording. As an alternative, an overlay, blank chart, or non-set-up chart may be used in conjunction with a chart containing the visual indicia to determine programming features by looking through both substrates in overlying registration. Particularly if the pen does not actually mark the recording surface, a chart with set-up indicia may not be required at all, and a printed area or label, outside or under the chart may be used instead. One example is depicted in FIG. 3, where a column 302 registered to pen pivoting is used in conjunction with tables 304 for programming purposes according to the written instructions. Again, the area 302 and tables 304 may be on a chart, label, or printed area on the recorder.

As discussed above, the particular list of programming features shown in the figures is not critical to the invention, in that more or fewer parameters may be added or deleted, depending upon the type of chart and/or environment to be monitored. For example, the following additional parameters are applicable to the invention, with the understanding that this list is not exhaustive:

Date

Time of day

Controller parameters (e.g., ramp, scale, tuning of PID valves)

Timer functions

Math functions (e.g., totalizer, square root)

Event messages

Password/lockout

Communication/output

Calibration

I claim:

1. A method of programming an instrument of the type wherein a marking implement is used to mark a surface, comprising the steps of:
providing a surface including visible options relating to the programming of the instrument;
storing information relating to the location of the options on the surface;
moving the marking implement and/or surface relative to one another so that the marking implement is aligned with one of the visible options; and
selecting the option if desired.

2. The method of claim 1, wherein the implement marks the surface in selecting the desired option.

3. The method of claim 2, wherein the options are selected by underscoring, circling, highlighting or overstriking.

4. The method of claim 1, wherein the instrument is a chart recorder and the surface is on a chart.

5. The method of claim 4, wherein the chart is a circular chart.

6. The method of claim 1, wherein the options relate to one or more of the following:
probe type, chart speed, chart type, temperature, humidity, vibration, scaling, input averaging, external control, date or time, a mathematical function, an event message, the function of a communications channel, calibration, or password protection.

7. The method of claim 1, further including the step of indexing the surface relative to a start position in conjunction with the step of storing information relating to the location of the visual options.

8. The method of claim 1, further including the step of marking a new surface in response to a user command subsequent to the programming of the instrument to obtain a record of currently selected options.

9. A method of programming a chart recorder having a pen to mark a chart, comprising the steps of:
providing a chart including printed parameters relating to the programming of the recorder;
placing the chart in a start position, enabling the recorder to advance to known positions on the chart using movements of the pen, chart, or both;
indexing the pen relative to the printed parameters so as to select certain of the parameters and marking the chart with the pen; and
programming the recorder by correlating the position of the pen relative to the chart during the selection of the parameters.

10. The method of claim 9, wherein the known locations on the chart are in two dimensions.

11. The method of claim 9, wherein the chart is a circular chart.

12. The method of claim 9, wherein the printed parameters relate to one or more of the following:
probe type, chart speed, chart type, temperature, humidity, vibration, scaling, input averaging, external control, date or time, a mathematical function, an event message, the function of a communications channel, calibration, or password protection.

13. The method of claim 9, wherein the parameters are selected by underscoring, circling, highlighting, or overstriking.

14. The method of claim 9, further including the step of marking a new chart in response to a user command subsequent to the programming of the instrument to obtain a record of currently selected options.
